(19) United States
(12) Patent Application Publication
(10) Pub. No.: US 2025/0369410 A1
(43) Pub. Date: Dec. 4, 2025

(54) FUEL INJECTOR AND NOZZLE ASSEMBLY CONFIGURED FOR LIMITING CAVITATION DAMAGE

(71) Applicant: Caterpillar Inc., Peoria, IL (US)

(72) Inventors: Zhenyu Li, Peoria, IL (US); Manjunath Bannur Nagaraja, Naperville, IL (US); Benjamin R. Tower, Varna, IL (US)

(73) Assignee: Caterpillar Inc., Peoria, IL (US)

(21) Appl. No.: 18/733,132

(22) Filed: Jun. 4, 2024

(51) Int. Cl. F02M 61/18; F02M 61/16

(52) U.S. Cl. CPC F02M 61/184; F02M 61/168

(57) ABSTRACT

A fuel injector in an engine system includes a nozzle having a plurality of spray orifices, and forming a check seat and a sac. A nozzle check is movable in the nozzle between a closed position in contact with the check seat, and an open position. The nozzle check includes a tip having a flat nib and an outer tip surface profiled to define a seating line for sealing with the check seat. The arrangement is associated with fuel flow patterns having reduced risk of cavitation damage via biasing high-velocity flows of fuel away from an outer sac wall. Related apparatus and methodology is also disclosed.

### TECHNICAL FIELD

The present disclosure relates generally to a fuel injector, and more particularly to a nozzle check assembly configured for limiting cavitation erosion during service.

### BACKGROUND

Internal combustion engines are well-known and widely used throughout the world for purposes ranging from propulsion of land vehicles and marine vessels to operation of pumps, compressors, and electrical generators, to name a few examples. In certain engine systems, notably in many heavier-duty engines, the fuel system may be the most complicated and expensive part of the engine platform. Over the course of many hours of engine operation, fuel system components can be subjected to extremely harsh conditions, including high fuel pressures, rapid motion of valve components and hard impacts upon valve seats, and high-velocity flows of fuel. Even seemingly minor changes to the size, shape, or surfaces, of fuel injector components, for example, can have outsized effects upon operation and performance. As a result, there is often high value placed upon robust reliability, predictability, and optimized service life of components.

When fuel system components are disassembled for inspection, service, repair, or replacement, it is not uncommon to observe cavitation damage to various parts, including valves, valve seats, and sometimes fuel passages within individual fuel injectors. Cavitation damage can negatively impact performance requiring various strategies for compensation, if even possible, and in some instances even resulting in catastrophic engine failure. One known strategy for predicting cavitation damage in a fuel injector is set forth in U.S. Pat. No. 7,912,687B2 to Stockner et al.

### SUMMARY

In one aspect, a fuel injector includes a fuel injector housing having a nozzle with a plurality of spray orifices formed therein, and an inner nozzle surface forming a check seat and a sac. The fuel injector also includes a nozzle check movable in the nozzle between a closed position in contact with the check seat, and an open position. The nozzle check defines a check axis and includes a tip having a flat nib and an outer tip surface having a first profiled section extending between the flat nib and a second profiled section, and defining a seating line between the first profiled section and the second profiled section.

In another aspect, a nozzle assembly for a fuel injector includes a nozzle having a terminal end bulb, and including an inner nozzle surface forming a check seat and a sac, and having a plurality of spray orifices formed therein and extending from the sac to an outer nozzle surface. The nozzle assembly further includes a nozzle check movable between a closed position in contact with the check seat, and an open position. The nozzle check defines a check axis, and includes a tip tapered down from an outer check shaft surface to a flat nib and defining a seating line located axially between the flat nib and the outer check shaft surface. The tip further defines a seat width dimension at the seating line, and a seat-flat dimension less than the seat width dimension.

In still another aspect, a method of operating a fuel injector includes reducing a closing hydraulic pressure on a nozzle check in a fuel injector defining a check axis, and lifting the nozzle check, based on the reducing the closing hydraulic pressure, from a closed position in contact with a check seat at a seating line. The method further includes fluidly connecting a fuel passage to a sac in the fuel injector through a volume defined between an outer tip surface of the nozzle check and the check seat together defining a differential angle opening from the seating line in a direction of the sac. The method still further includes advancing fuel from the fuel passage past a flat nib of the nozzle check positioned at a distance axially outward from the seating line effective to bias high-velocity flows of the fuel away from an inner nozzle surface forming the sac, and spraying the fuel out of a plurality of spray orifices of the fuel injector.

### BRIEF DESCRIPTION OF DRAWINGS

FIG. 1 is a diagrammatic view of an internal combustion engine system, according to one embodiment;

FIG. 2 is a sectioned side diagrammatic view of a fuel injector nozzle assembly, according to one embodiment;

FIG. 3 is a diagrammatic view of a nozzle check, according to one embodiment;

FIG. 4 is a side diagrammatic view of a tip portion of the nozzle check as in FIG. 3;

FIG. 5 is another diagrammatic view of a portion of the nozzle check as in FIG. 3;

FIG. 6 is an image illustrating relative fuel flow velocities just after opening a nozzle check in a fuel injector, according to one embodiment; and

FIG. 7 is an image illustrating relative fuel velocities just prior to closing a nozzle check in a fuel injector, according to one embodiment.

### DETAILED DESCRIPTION

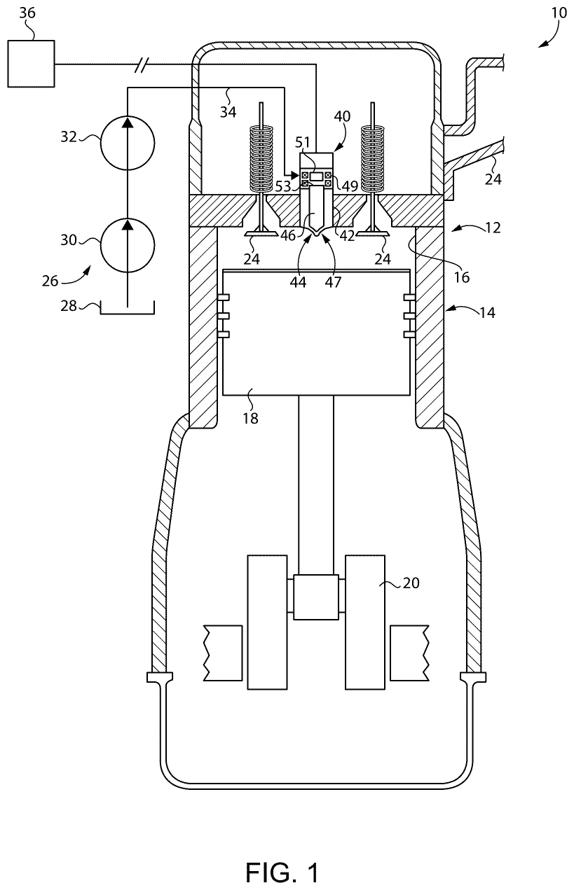

Referring to FIG. 1, there is shown an engine system 10 according to one embodiment. Engine system 10 includes an internal combustion engine 12 having an engine housing 13 with a combustion cylinder 16 formed therein. A piston is movable in cylinder 16 between a bottom-dead-center position and a top-dead-center position in a generally conventional manner to rotate a crankshaft 20. Cylinder 16 may be one of a plurality of cylinders, including any number of cylinders, in any suitable arrangement such as an in-line pattern, a V-pattern, or still another. Engine 12 may include a compression-ignition diesel engine operated on a suitable compression-ignition fuel, such as a diesel distillate fuel although the present disclosure is not thereby limited. Engine 12 may be operated in a four-stroke engine cycle. Engine 12 further includes an intake manifold 22 structured to convey intake air to cylinder 16 for combustion, or potentially intake air and recirculated exhaust gas, and will be conventionally equipped with exhaust apparatus for conveying exhaust from cylinder 16. A plurality of engine valves 24, typically including two intake valves and two exhaust valves, are provided for controlling the supplying of intake air and expelling of exhaust from cylinder 16, again in a generally conventional manner. Engine system 10 can be applied for any known purpose including operating a driveline in a land vehicle or a marine vessel, operating a pump, a compressor, or a generator, for example.

Engine system 10 further includes a fuel system 26. Fuel system 26 includes a fuel supply 28, such as a diesel fuel tank, a low-pressure pump 30 and a high-pressure pump 32 feeding fuel from fuel supply 28 to engine 12 by way of a fuel supply conduit 34. An electronic control unit or ECU 36 is provided to electronically control and/or monitor various of the components in engine system 10. In the illustrated embodiment, fuel system 26 is arranged with low pressure pump 30 and high-pressure pump 32 to feed fuel at an increased pressure to a fuel injector 40. Supply and pressurization of fuel for injection can be performed in any suitable manner, including, for example, a so-called common rail arrangement, using a cam-actuated or hydraulically-actuated fuel pressurization plunger, or still others. Fuel injector 40 is positioned to extend into cylinder 16 and is thus understood as a direct fuel injector.

Fuel injector 40 includes a fuel injector housing 42 having a nozzle 44. A nozzle check 46 further discussed herein is positioned in nozzle 44 and forms, together with nozzle 44, a nozzle assembly 47. Fuel injector 40 also includes an electrical actuator 49, such as a solenoid electrical actuator. Electrical actuator 49 is operable to actuate an injection control valve 51 to vary a pressure of a fluid such as fuel or another control fluid upon a closing hydraulic surface 53 of nozzle check 46. Nozzle check 46 can be operated to control start of fuel injection, end of fuel injection, and potentially a manner of fuel injection such as an injection rate shape, according to techniques well-known in the art. Briefly, operating control valve 51 can control a closing hydraulic pressure acting upon closing hydraulic surface 53 tending to maintain nozzle check 46 closed. When the pressure acting on closing hydraulic surface 53 is reduced by opening control valve 51 fuel pressure inside fuel injector housing 42 can act upon opening hydraulic surfaces of nozzle check 46 to urge open nozzle check 46 to commence fuel injection. When the hydraulic pressure upon closing hydraulic surface 53 is increased nozzle check 46 will be moved closed to end fuel injection.

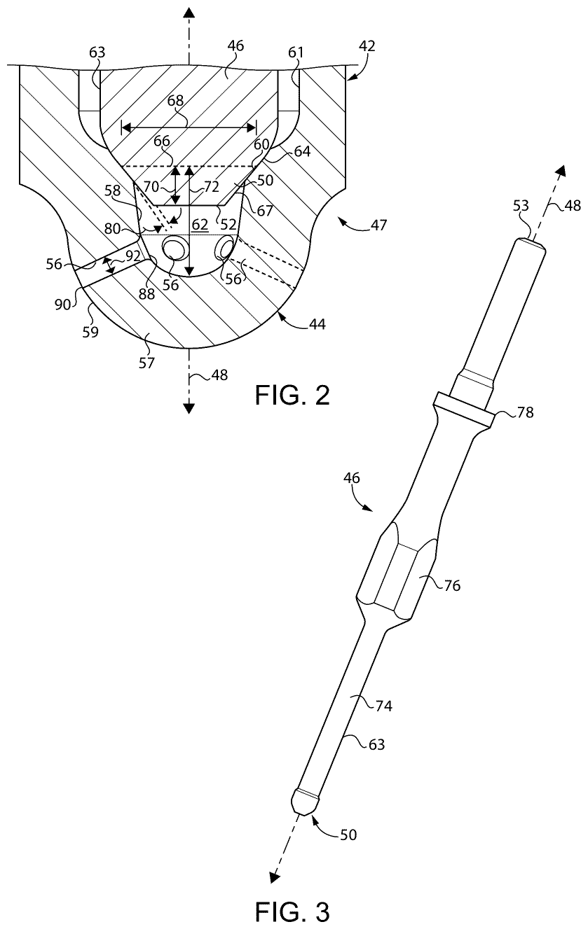

Referring also now to FIG. 2, nozzle 44 includes a plurality of spray orifices 56 formed therein. Nozzle 44 also includes an inner nozzle surface 58 forming a check seat 60 and a sac 62. Nozzle check 46 is movable in nozzle 44 between a closed position in contact with check seat 60, and an open position as noted above. As illustrated, nozzle 44 may include a terminal end bulb 57, with spray orifices 56 formed in end bulb 57 and extending from sac 62 to an outer nozzle surface 58. Nozzle check 44 defines a check axis 48 and includes a tip 50. Tip 50 may be tapered down from an outer check shaft surface 63 to a flat nib 52. Flat nib 52 may be planar and defines a plane oriented normal to check axis 48.

Outer tip surface 54 further includes a first profiled section 67 extending between flat nib 52 and a second profiled section 64. Tip 50 further defines a seating line 66 between first profiled section 67 and second profiled section 64. Seating line 66 can be understood to be located axially between flat nib 52 and outer check shaft surface 63. In an embodiment, first profiled section 67 includes a conical section, and second profiled section 64 includes a radiused section. Seating line 66 can be understood as a circumferential line of contact around check axis 48 and represents a location that tip 50 fluidly seals against check seat 60 when nozzle check 46 is closed. Seating line 66 will thus be formed at an axial location at which first profiled section 67 intersects second profiled section 64. Profiles of first profiled section 67 and second profiled section 64 may be circumferentially uniform around check axis 48.

Tip 50 further defines a seat width dimension 68 at seating line 66. Seat width dimension 68 can be understood as a diameter of a circle defined by seating line 66 extending through tip 50. Tip 50 further defines a seat-flat dimension 70 less than seat width dimension 68. Seat-flat dimension 70 is understood as a line extending parallel to, or colinear with, check axis 48 from a plane of the circle defined by seating line 66 and a plane defined by flat nib 52. In a refinement, seat width dimension 68 is from about two times to about four times seat-flat dimension 70. In a further refinement, a ratio of seat width dimension 68 to seat-flat dimension 70 is about 3:1. In a still further refinement, the subject ratio is about 3.2:1. As used herein, the term “about” or like relative terms should be understood to mean generally or approximately as would be understood by a person of ordinary skill in the art, for example applying conventional rounding or another art-recognized standard.

Referring also now to FIG. 3, there are shown additional features of nozzle check 46. As noted above nozzle check 46 defines check axis 48. Nozzle check 46 may be of elongate form extending from closing hydraulic surface 53 to tip 50. A shaft section 74 extends from tip 50 and includes thereon outer check shaft surface 63. A guide section 76 may be formed adjacent to shaft section 74, and in some embodiments may be equipped with a plurality of outer guide surfaces structured to contact other parts of fuel injector 40 to guide nozzle check 46 as it travels between the respective open and closed positions. Nozzle check 46 may also include a spring shoulder 78 structured to contact a biasing return spring that may assist in maintaining nozzle check 46 closed and in returning to the closed position once opened.

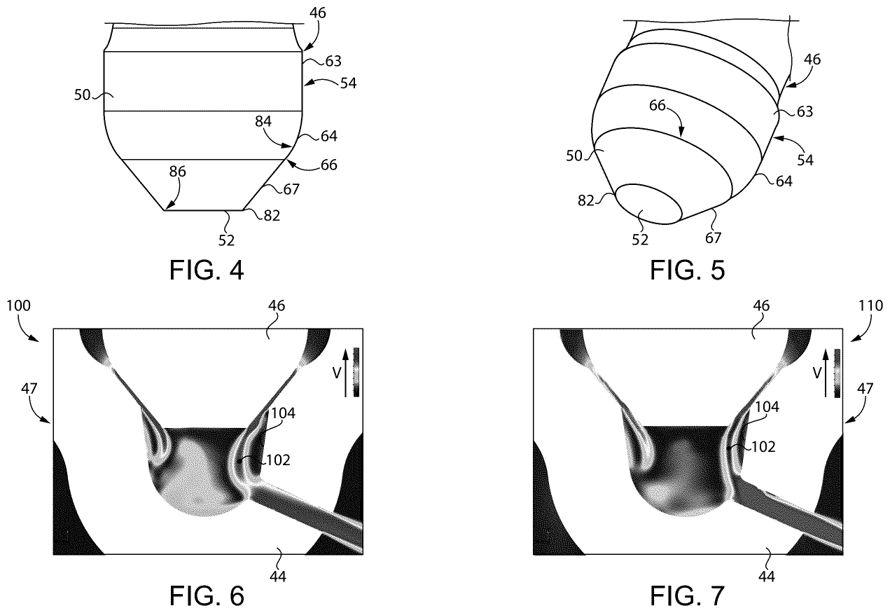

Referring also now to FIGS. 4 and 5, there are shown enlarged views of tip 50 in greater detail. FIGS. 4 and 5 illustrate the radiused shape of second profiled section 64 and the conical shape of first profiled section 67 with seating line 66 defined at an intersection thereof. Second profiled section 64 may transition to outer check shaft surface 63 having a cylindrical shape. Outer check shaft surface 63 may be narrowed or “necked-down” from a cylindrical portion adjoining second profiled section 64 in a direction of closing hydraulic surface 53.

It can further be seen from FIGS. 4 and 5 that tip 50 forms an angular corner 82 at an intersection of flat nib 52 and first profiled section or conical section 67. Angular corner 82 may extend circumferentially around check axis 48 and is sharp relative to other locations where surfaces intersect upon nozzle check 46. In an embodiment, radiused section or second profiled section 64 defines a first radius 84, and angular corner 82 defines a second radius 86 smaller than first radius 84. Second radius 86 may be smaller than first radius 84 by a factor of about 100 or greater in some embodiments. In one implementation, first radius 84 is about 1.3 millimeters, and second radius 86 is about 10 microns or 0.01 millimeters.

Returning focus to FIG. 2, in an embodiment seat width dimension 68 may be about 2.7 millimeters and seat-flat dimension 70 may be about 0.84 millimeters. A seat-bottom distance 72 defined between seating line 66 and a bottom of sac 62, downward in the FIG. 2 illustration, may be about 2.19 millimeters. Thus, seat width dimension 68 may be greater than seat-bottom dimension 72.

Also in the illustrated embodiment, a differential angle 80 opening in a direction of sac 62 is defined between check seat 60 and conical section or first profiled section 67. Differential angle 80 may originate at seating line 66 such that a relatively minute clearance is defined between injector housing 42 and tip 50 extending in a downstream direction from a fuel passage 61 defined between nozzle check 46 and injector housing 42 towards spray orifices 56. In an embodiment, differential angle 80 may be less than 1°. In a refinement, differential angle 80 may be equal to about 0.5°.

FIG. 2 also illustrates additional features of spray orifices 56. In one implementation, a number of spray orifices 56 is exactly five. Three spray orifices 56 are fully visible in the illustration of FIG. 2. A fourth spray orifice 56 is shown in phantom lines. It will be understood a fifth spray orifice is above the plane of the page and not visible. Spray orifices 56 may be spaced uniformly circumferentially around check axis 48 and oriented at a uniform spray angle, including a spray angle greater than 90°, and potentially about 120° or greater. Each respective one of spray orifices 56 may extend from a larger radiused inner opening 88 to a smaller radiused outer opening 90. Larger radiused inner opening 88 may be understood to be formed by a relatively smooth transition (larger radius) between an interior of the respective spray orifice 56 and inner nozzle surface 58, in contrast to a relatively sharp transition (smaller radius) between an interior of the respective spray orifice and outer nozzle surface 59. Each respective spray orifice 56 may further define a spray orifice diameter 92 reduced in an outward direction of smaller radiused outer opening 90. In an embodiment, each respective spray orifice 56 may define a narrowing taper from larger radiused inner opening 88 to smaller radiused outer opening 90 that is equal to about 20 microns or about 0.020 millimeters.

### INDUSTRIAL APPLICABILITY

Referring to the drawings generally, but focusing now on FIG. 6, there is shown an image 100 illustrating nozzle check 46 within nozzle 44 as it might appear just having commenced lifting from a closed position, in response to reducing a closing hydraulic pressure on closing hydraulic surface 53. Lifting nozzle check 46 fluidly connects a fuel passage 61 defined between nozzle check 46 and injector housing 42 to sac 62 through a volume defined between outer tip surface 54 and check seat 60 together defining differential angle 80. At the state shown in FIG. 6, fuel is advanced through that volume between nozzle check 46 and nozzle 44, showing a high-velocity flow of fuel 102 into one spray orifice.

An image 110 in FIG. 7 shows nozzle check 46 and nozzle 44 as they might appear just prior to returning nozzle check 46 to the closed position. A high-velocity flow of fuel 102 is also evident in FIG. 7. It can further be noted that high velocity fuel flows 102 are positioned away from, mostly radially inward of, a sac wall 104.

As noted above, cavitation erosion is a problem that can be observed in certain fuel system components. The present disclosure provides a combination of features considered to limit cavitation erosion of a nozzle check as well as surrounding injector housing material. One mechanism causing cavitation erosion is believed to be the presence of high-velocity flows of fuel along and in contact with internal walls of the fuel injector, thus biasing high-velocity flows of fuel away from inner sac wall 104 as depicted in FIGS. 6 and 7 can be associated with reduced or eliminated cavitation erosion risk.

According to the present disclosure, utilizing flat nib 52 positioned at a distance axially outward from seating line 66 and relative to spray orifices 56, in cooperation with differential angle 80, can effectively bias the high-velocity flows of fuel away from sac wall 104. The relatively sharp transition formed by angular corner 82, also at an appropriate axial location relative to seating line 66, is believed to assist with obtaining desired trajectories of the high-velocity flows of fuel. Moreover, providing second profiled section 64 defining radius 84 may contribute to limiting migration of seating line 66 over time. In some embodiments, fuel injector 40 can remain in continuous service in engine system 10 from a time of deployment of engine system 10 in the field to a time of top end overhaul.

Another target for reduced cavitation erosion relates to spray orifices 56 themselves. It has been discovered the relatively blended transition between sac 62 and spray orifices 56 provided by larger radiused inner openings 88 coupled with the throttling down provided by reduced orifice diameter 92 can assist in limiting high-velocity flows of fuel from contact with material forming spray orifices 56.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel injector comprising:
a fuel injector housing including a nozzle having a plurality of spray orifices formed therein and an inner nozzle surface forming a check seat and a sac;
a nozzle check movable in the nozzle between a closed position in contact with the check seat, and an open position; and
the nozzle check defining a check axis and including a tip having a flat nib and an outer tip surface having a first profiled section extending between the flat nib and a second profiled section and defining a seating line between the first profiled section and the second profiled section.

2. The fuel injector of claim 1 wherein a differential angle opening in a direction of the sac is defined between the check seat and the first profiled section.

3. The fuel injector of claim 2 wherein the differential angle is less than 1°.

4. The fuel injector of claim 1 wherein the first profiled section includes a conical section, and the second profiled section includes a radiused section.

5. The fuel injector of claim 4 wherein the tip forms an angular corner at an intersection of the flat nib and the conical section and extending circumferentially around the check axis.

6. The fuel injector of claim 5 wherein the radiused section defines a first radius, and the angular corner defines a second radius smaller than the first radius.

7. The fuel injector of claim 6 wherein the second radius is smaller than the first radius by a factor of about 100 or greater.

8. The fuel injector of claim 1 wherein the tip defines a seat width dimension at the seating line, and a seat-flat dimension that is less than the seat width dimension.

9. The fuel injector of claim 8 wherein the seat width dimension is from about two times to about four times the seat-flat dimension.

10. The fuel injector of claim 1 wherein a number of the plurality of spray orifices is five, and each respective one of the plurality of spray orifices extends from a larger radiused inner opening to a smaller radiused outer opening, and defines a spray orifice diameter reduced in a direction of the smaller radiused outer opening.

11. A nozzle assembly for a fuel injector comprising:
a nozzle including a terminal end bulb, and including an inner nozzle surface forming a check seat and a sac, and having a plurality of spray orifices formed therein and extending from the sac to an outer nozzle surface;
a nozzle check movable between a closed position in contact with the check seat, and an open position; and
the nozzle check defining a check axis, and including a tip tapered down from an outer check shaft surface to a flat nib and defining a seating line located axially between the flat nib and the outer check shaft surface; and
the tip further defining a seat width dimension at the seating line, and a seat-flat dimension less than the seat width dimension.

12. The nozzle assembly of claim 11 wherein the seat width dimension is from about two times to about four times the seat-flat dimension.

13. The nozzle assembly of claim 12 wherein a ratio of the seat width dimension to the seat-flat dimension is about 3:1.

14. The nozzle assembly of claim 11 wherein the tip includes an outer tip surface having a conical section extending to the flat nib, and a radiused section extending to the outer check shaft surface, and the seating line is defined between the conical section and the radiused section.

15. The nozzle assembly of claim 14 wherein:
the tip forms an angular corner at an intersection of the flat nib and the conical section and extending circumferentially around the check axis; and
the radiused section defines a first radius, and the angular corner defines a second radius smaller than the first radius.

16. The nozzle assembly of claim 14 wherein a differential angle equal to about 1° or less and opening in a direction of the sac is defined between the check seat and the conical section.

17. A method of operating a fuel injector comprising:
reducing a closing hydraulic pressure on a nozzle check in a fuel injector defining a check axis;
lifting the nozzle check, based on the reducing the closing hydraulic pressure, from a closed position in contact with a check seat at a seating line;
fluidly connecting a fuel passage to a sac in the fuel injector through a volume defined between an outer tip surface of the nozzle check and the check seat together defining a differential angle opening from the seating line in a direction of the sac;
advancing fuel from the fuel passage past a flat nib of the nozzle check positioned at a distance axially outward from the seating line effective to bias high-velocity flows of the fuel away from an inner nozzle surface forming the sac; and
spraying the fuel out of a plurality of spray orifices of the fuel injector.

18. The method of claim 17 wherein the nozzle check defines a seat width dimension at the seating line, and a seat-flat dimension, and a ratio of the seat width dimension to the seat-flat dimension is from about two to about four.

19. The method of claim 17 wherein the differential angle is about 1° or less.

20. The method of claim 17 wherein the advancing fuel from the fuel passage includes advancing the fuel past an angular corner of the nozzle check defined at an intersection of the flat nib and a conical surface of the nozzle check extending from the flat nib to the seating line.
